(19) United States
(12) Patent Application Publication
(10) Pub. No.: US 2009/0073113 A1
(43) Pub. Date: Mar. 19, 2009

(54) Presenter model

(75) Inventor: Ting-Hsiang Lu, Taipei (TW)

Correspondence Address: BACON & THOMAS, PLLC, 625 SLATERS LANE, FOURTH FLOOR, ALEXANDRIA, VA, 22314-1176, US

(73) Assignee: SANYEI CORPORATION (TAIWAN) LTD., Taipei (TW)

(21) Appl. No.: 11/902,092

(22) Filed: Sep. 19, 2007

(51) Int. Cl. G09G 5/00

(52) U.S. Cl. 345/156

(57) ABSTRACT

A presenter model includes a presenter having a wireless signal transmitting unit and an accommodating box having a wireless signal receiving unit. The accommodating box having the wireless signal receiving unit receives the wireless signals transmitted by the wireless signal transmitting unit of the presenter. Via a USB port connected with an electronic apparatus, the command received is transmitted to the electronic apparatus, thereby achieving the function of transmitting the signals of the presenter. The accommodating box can be provided thereon with at least one insertion slot for a USB interface and at least one insertion slot for an IEEE1394 interface, thereby serving as digital expansion slots. The accommodating box allows the presenter to be disposed therein and combined therewith, thereby increasing the convenience in carrying and storing the presenter.

### BACKGROUND OF THE INVENTION

1. Field of the Invention

The present invention relates to a presenter model, and in particular to a presenter model in which an accommodating box having a wireless signal receiving unit is combined with a presenter.

2. Description of Prior Art

The wireless presenter model available in the market is provided with a presenter having a wireless signal transmitting unit and a wireless signal receiver. The wireless signal receiver is connected with an electronic apparatus (such as a Note Book), so that the receiver can receive the wireless signals transmitted by the presenter and send the signals back to the electronic apparatus. The presenter is provided with a cursor controlling model and a wireless signal transmitting circuit. The cursor controlling model includes a rolling ball and a cursor controlling circuit associated with the rolling ball. A user operates the rolling ball on the presenter by his/her finger. In this way, the controlling circuit transmits the signals to the wireless signals receiver, and then the wireless signals receiver transmits the signals to the electronic apparatus, thereby generating a corresponding operation on a screen of the electronic apparatus connected in series, such as a paging action and other instructions for the operation of the cursor. However, with the conventional wireless presenter, if both the wireless signal receiver and the presenter having the wireless signal transmitting unit are not carried, each of them cannot be used separately. Therefore, if any one is lost, it will be very inconvenient. Even, since no container is provided for accommodating and protecting the presenter, so that the button or the rolling ball on the presenter often gets damaged.

Therefore, in view of the drawbacks of the above-mentioned conventional wireless presenter, the inventor proposes the present invention to overcome the above problems based on his expert experience and deliberate researches.

### SUMMARY OF THE INVENTION

According to the above, in order to solve the drawbacks of prior art, the object of the presenter model of the present invention is to combine a wireless signal receiving unit with an accommodating box. With the double functions of receiving the signals of the presenter and accommodating the presenter, the convenience in carrying and storing the presenter can be increased.

Another object of the presenter model of the present invention is to serve as digital expansion slots for a USB interface and an IEEE1394 interface.

The presenter model of the present invention includes a presenter having a wireless signal transmitting unit and an accommodating box having a wireless signal receiving unit. The presenter having a wireless signal transmitting unit and an accommodating box having a wireless signal receiving unit are provided with a wireless signal transmitting circuit and a wireless signal receiving circuit, respectively. Further, the accommodating box is provided with an insertion slot for a USB interface, an insertion slot for an IEEE1394 interface and a USB port. Further, the presenter is provided thereon with a cursor controlling model, a play control model and a laser light emitting model, each of which is provided with a control circuit for being electrically connected with the wireless signal transmitting circuit. With the cursor controlling model and the play control model, the functions of controlling the movement of the cursor, reviewing data, paging the contents of presentation and playing a movie can be operated and controlled. With this arrangement, the wireless signal receiving unit receives the wireless signals transmitted by the wireless signal transmitting unit via an antenna. After the wireless signal receiving unit receives the wireless signals via the antenna, the signals are transmitted via the USB port connected with an electronic apparatus, thereby achieving the function of controlling the electronic apparatus for presentation. Further, the laser light emitting model can be used to generate a light spot for indicating the key points of the presentation, so that the operator can express the contents of the presentation more clearly.

The feature of the present invention lies in that the presenter and the accommodating box having the wireless signal receiving unit are combined with each other, thereby increasing the convenience in carrying, storing and protecting the presenter.

Preferably, the accommodating box is provided thereon with at least one insertion slot for a USB interface and at least one insertion slot for an IEEE1394 interface.

The above objects and functional features of the present invention will be described with reference to preferred embodiments thereof and the accompanying drawings.

### BRIEF DESCRIPTION OF THE DRAWINGS

FIG. 1 is a schematic view of a preferred embodiment of the present invention;

FIG. 2 is a schematic view showing the structure in which a presenter of the preferred embodiment of the present invention is disposed in an accommodating box;

FIG. 3 is a cross-sectional view showing a wireless signal transmitting unit of the preferred embodiment of the present invention;

FIG. 4 is a block view showing a wireless signal receiving unit of the preferred embodiment of the present invention; and

FIG. 5 is a block view showing a wireless signal transmitting unit of the preferred embodiment of the present invention.

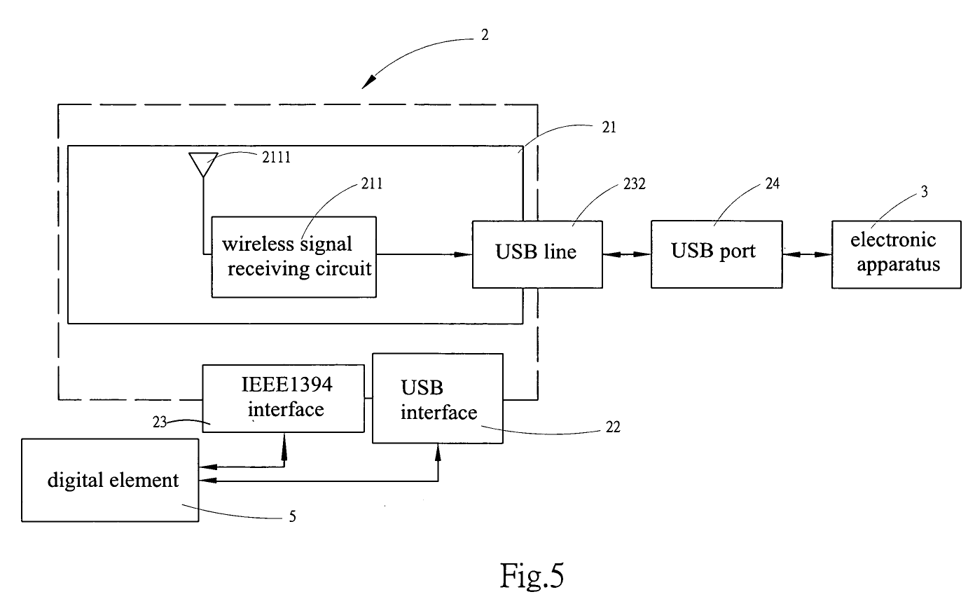

### DETAILED DESCRIPTION OF THE INVENTION

In order to further understand the other advantages, objects, technical characteristics and effects of the present invention, a detailed description of a preferred embodiment of the present invention will be made with reference to the accompanying drawings.

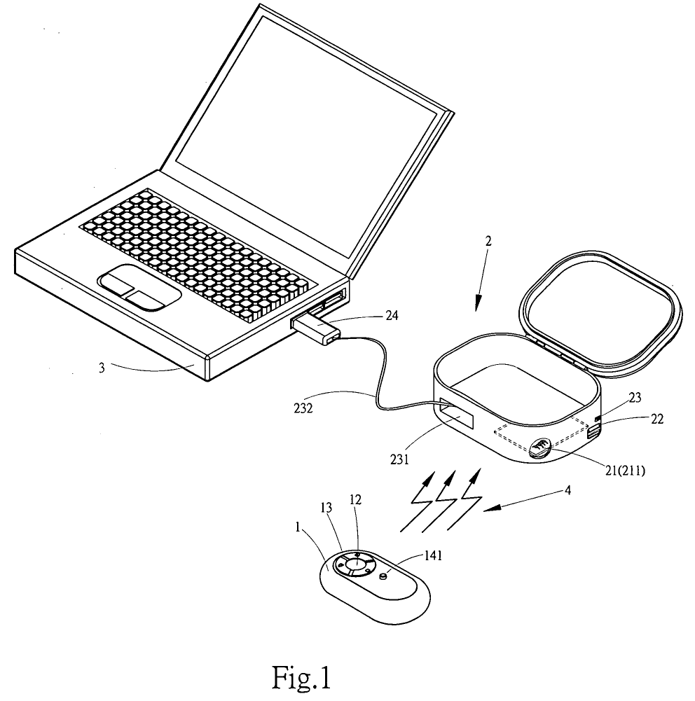

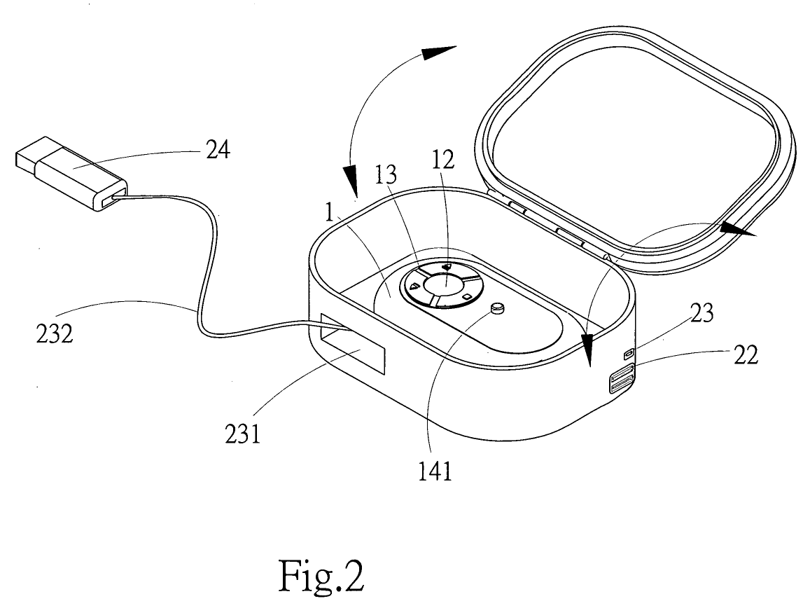

The present invention provides a presenter model. The drawings show a preferred embodiment of the present invention. With reference to FIGS. 1 and 2, a wireless signal transmitting unit 1 is provided with a cursor controlling model 12, a play control model 13 and a button 141. A wireless signal receiving unit 21 is provided in an accommodating box 2 and combined with the accommodating box 2. The accommodating box 2 is further provided thereon with an insertion slot 22 for a USB interface, an insertion slot 23 for an IEEE1394 interface and a USB transmission line 232. The USB transmission line connects a USB port 24 with an electronic apparatus 3 and transmits the signals received by the wireless signal receiving unit 21 back to the electronic apparatus 3, thereby achieving an interactive operation. The accommodating box 2 is provided thereon with a notch 231 for allowing the USB port 24 to be accommodated therein.

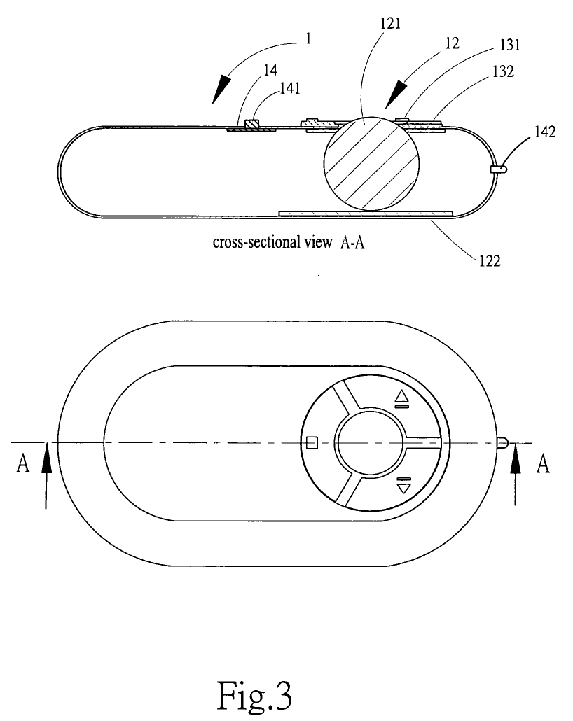

With reference to FIG. 3, the presenter 1 is provided with a cursor controlling model 12. The cursor controlling model 12 includes a rolling ball 121 and a cursor controlling circuit 122. The rolling ball 121 is disposed on the cursor controlling circuit 122. A portion of the rolling ball 121 is exposed to the outside of the presenter 1. When an operator touches and controls the rolling ball 121 by his/her finger, the cursor controlling circuit 122 generates a signal and transmits it to a wireless signal transmitting circuit 111. In this way, the operator can control the cursor by manipulating the rolling ball 121 to move the cursor on a screen of the electronic apparatus 3, thereby achieving actions of reviewing data, paging or the like.

The presenter 1 is further provided with a play control model 13 as shown in FIG. 1. The play control model 13 includes a play control model circuit 132 and play control button 131. The play control button 131 is provided on the play control model circuit 132. The play control button 131 protrudes from the presenter 1 and can be arranged circumferentially in the periphery of the rolling ball 121 of the cursor controlling model 12. When the operator touches the play control button 131 slightly with his/her finger, the play control model circuit 132 generates a signal and transmits it to the wireless signal transmitting circuit 111. With a wireless signal transmitting antenna 112 transmitting the signal to the wireless signal receiving unit 21 of the accommodating box 2, the electronic apparatus 3 can be controlled. The operator can perform the actions of playing a movie, stopping the movie and reviewing data via the play control button 131.

The presenter 1 is further provided with a laser light emitting circuit 14. The laser light emitting circuit 14 comprises a button 141 and a laser bulb 142. When the operator presses the button 141 provided on the presenter 1 to activate the operation, the laser bulb 142 can be driven to emit the light, so that the light irradiates to a predetermined position for indication.

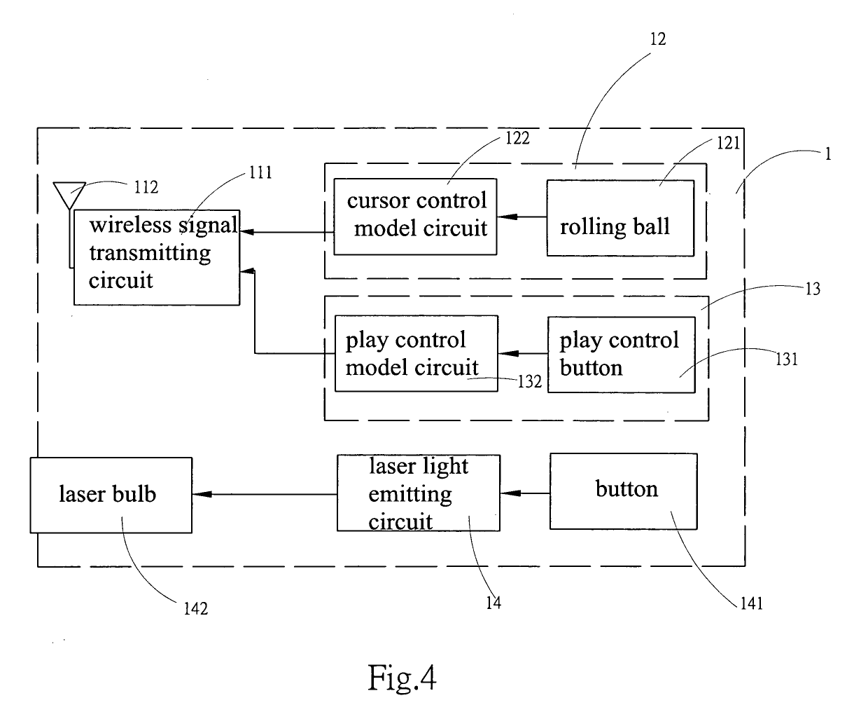

With reference to FIGS. 1, 3 and 4, the wireless signal emitting unit 11 of the presenter 1 is provided with the wireless signal transmitting circuit 111. The wireless signal receiving unit 21 of the accommodating box 2 is provided with the wireless signal receiving circuit 211. When the rolling ball 121 or the play control button 131 is touched, the signal can be transmitted to the wireless signal transmitting circuit 111 via the cursor controlling circuit 121 or the play control model circuit 132. Via a wireless signal transmitting antenna 112 provided in the presenter 1, a wireless signal 4 can be transmitted to a wireless signal receiving antenna 2111 provided on the accommodating box 2, thereby receiving the wireless signal 4. Then, the signal is transmitted to the wireless signal receiving circuit 211 via the USB transmission line 232. Since the USB port connected to another end of the transmission line 232 in the accommodating box 2 is inserted into the electronic apparatus 3, the transmission of signals can be achieved.

Further, the accommodating box 2 is provided with at least one insertion slot 22 for the USB interface, or at least one insertion slot 23 for the IEEE1394 interface. With this arrangement, these insertion slots can be used as digital expansion slots when being connected with other digital elements (such as an external hard disk, PDA, mouse, keyboard and etc.).

According to the above, the present invention has not been published or used in public, and thus really has novelty and inventive steps. Therefore, the present invention conforms to the requirements for a utility model patent.

Although the present invention has been described with reference to the foregoing preferred embodiment, it will be understood that the invention is not limited to the details thereof. Various equivalent variations and modifications with regard to the construction or arrangement thereof can still occur to those skilled in this art in view of the teachings of the present invention. Thus, all such variations and equivalent modifications are also embraced within the scope of the invention as defined in the appended claims.

What is claimed is:

1. A presenter model, comprising:
a presenter provided therein with a wireless signal transmitting circuit;
an accommodating box allowing the presenter to be disposed therein, and provided with at least one wireless signal receiving circuit; and
a USB port connected at one end thereof to the accommodating box, the other end of the USB port being inserted into an electronic apparatus,
wherein when the presenter is used, a wireless signal of the presenter is transmitted to and thus received by the wireless signal receiving circuit of the accommodating box, and the signal is then transmitted to the electronic apparatus via the USB port.

2. The presenter model according to claim 1, wherein the accommodating box is provided with at least one insertion slot for a USB interface.

3. The presenter model according to claim 1, wherein the accommodating box is provided with at least one insertion slot for an IEEE1394 interface.
